(19) United States
(12) Patent Application Publication
(10) Pub. No.: US 2007/0136254 A1
(43) Pub. Date: Jun. 14, 2007

(54) System and method for processing integrated queries against input data stream and data stored in database using trigger

(76) Inventors: Hyun-Hwa Choi, Daejon (KR); Mi-Young Lee, Daejon (KR); Myung-Cheol Lee, Daejon (KR); Myung-Joon Kim, Daejon (KR)

Correspondence Address: LADAS & PARRY LLP, 224 SOUTH MICHIGAN AVENUE, SUITE 1600, CHICAGO, IL, 60604, US

(21) Appl. No.: 11/594,641

(22) Filed: Nov. 8, 2006

(30) Foreign Application Priority Data
Dec. 8, 2005 (KR) 10-2005-0119397
Mar. 16, 2006 (KR) 10-2006-0024423

(51) Int. Cl. G06F 17/30; G06F 7/00

(52) U.S. Cl. 707/3

(57) ABSTRACT

Provided are a system and a method for processing integrated queries against an input data stream and data stored in a database using trigger. The system for processing an integrated query against an input data stream and data stored in a database using a trigger, including: a data stream manager for managing a continuously inputted data stream; a trigger result manager for registering a trigger in a database which interworks with the trigger result manager and forming a set of results that are obtained by executing the registered trigger to thereby provide the set of results in real time; and an executer for processing an integrated query against the data stream from the data stream manager and data stored in the database, wherein the integrated query is processed by referring to the set of results from the trigger result manager for the data stored in the database.

### FIELD OF THE INVENTION

The present invention relates to a query processing system, and more particularly, to a system and a method for processing integrated queries against an input data stream and data stored in a database using trigger, which are capable of improving overall query performance by way of reducing time taken for processing data stored in a database using an efficient query processing technique.

### DESCRIPTION OF RELATED ART

In a ubiquitous computing environment, continuous query processing technologies have been necessarily required to process data in real time continuously created from Radio Frequency IDentification (RFID), Global Positioning System (GPS), various sensors such as a temporal sensor and a humidity sensor, and kinds of application programs.

For example, a sensor network in which lightweight sensor nodes are connected by radio communications can provide a variety of application services for kinds of ubiquitous environment such as environment watch of areas in which people cannot watch, automation and crime prevention at home and office, health monitoring, tracking of moving objects, network monitoring, logistics/circulation, web log, and the like.

Data processed for various kinds of application services as mentioned above is continuously created without any interruption. The amount of data so created is varied from hour to hour, and therefore, such data are required to be processed in real time.

In other words, in the ubiquitous computing environment, there has been an increased need for development of a data stream management system which processes a continuous query in order to recognize current circumstance in real time by constantly offering new results of queries registered by the user or application.

Under the ubiquitous computing environment, however, the understanding and judgment of a current circumstance may be incorrect only by the analysis of a data stream inputted in real time. Namely, when integrated analysis based on the past history or its related information is made, more correct and high-valued or reliable information can be acquired. Therefore, in order to provide high-valued information to a user or application through a continuous query, a conventional data stream management system supports an integrated query or integrated continuous query having historical data of a certain storage or its related data as well as the data stream inputted in real time.

Meanwhile, most of studies and developments up to now adopt a push-based approach for continuously inputted data stream and a pull-based approach for data stored in a database, wherein a process of an integrated query through a combination of the above approaches is executed. Accordingly, the conventional data stream management system that should provide process result of the integrated query in real time lowers performance in processing the overall integrated query because time spent for processing queries against the data stored in the database is longer than that of the inputted data stream.

That is, the conventional data stream management system employs the pull-based approach which always processes the queries after connecting to the database due to unawareness of whether or not a change happens in the data stored in the database. This decreases overall query performance because of a long processing time of the queries against the data stored in the database.

The following is a description of prior arts regarding improvement of query performance in the data stream management system.

One of such prior arts is U.S. Patent Publication No. 2005/0044063 published on Feb. 24, 2005, entitled “Data Query System Load Optimization.” This publication allows a data processing engine to re-execute a query against a relational database if a trigger recognizes any change in the database for optimization of query process repeatedly executed in the database. Also, the publication allows the query result to be reused in executing the same query, thereby optimizing the query repeatedly executed in the relational database. In this case, the trigger merely plays the role of sensing a change in the database.

However, this publication is limited to the relational database, rather than continuously inputted data stream, and also to the reuse of query result for the same query only.

Another prior art is proposed in an article entitled “Aurora: A New Model and Architecture for Data Stream Management,” VLDB Journal, Vol. 12, No. 2, pp. 120-139, August, 2003. This article is directed to a technique for processing a continuous query against a Tuple-based data bit stream inputted in real time and a database. That is, the article executes an integrated query process using a pull-based approach through connection points based on data of a general Tuple conception. Thus, this article has an advantage in that it enables the processing of the integrated query against the data stream inputted in real time through such connection points and data stored in the database.

However, this article is also restricted to the Tuple-based data and the relational database-based data, and employs the pull-based approach for the data stored in the database, which fails to achieve an optimum performance.

### SUMMARY OF THE INVENTION

It is, therefore, an object of the present invention to provide a system and a method for processing integrated queries against an input data stream and data stored in a database using trigger, which are capable of improving overall query performance by way of reducing time spent for processing data stored in a database using an efficient query processing technique.

In accordance with one aspect of the present invention, there is provided a system for processing an integrated query against an input data stream and data stored in a database using a trigger, including: a data stream manager for managing a continuously inputted data stream; a trigger result manager for registering a trigger in a database which interworks with the trigger result manager and forming a set of results that are obtained by executing the registered trigger to thereby provide the set of results in real time; and an executer for processing an integrated query against the data stream from the data stream manager and data stored in the database, wherein the integrated query is processed by referring to the set of results from the trigger result manager for the data stored in the database.

In accordance with another aspect of the present invention, there is provided a method for processing an integrated query against an input data stream and data stored in a database using a trigger, including the steps of: registering an integrated query; registering a trigger for data stored in a database; forming a set of results of the trigger automatically executed when a change happens in the database in real time; receiving a continuously inputted data stream; and processing the integrated query against the data stream and the data stored in the database, wherein the integrated query is executed by referring to the formed set of results for the data stored in the database.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 is a block diagram showing a configuration of an integrated query processing system in accordance with a preferred embodiment of the present invention;

FIG. 2 provides a flowchart illustrating a procedure of registering an integrated continuous query against an input data stream and data stored in a database in the integrated query processing system in accordance with another preferred embodiment of the present invention;

FIG. 3 presents a flowchart illustrating a procedure of creating and deleting a search XQuery trigger in the integrated query processing system in accordance with another preferred embodiment of the present invention;

FIG. 4 offers a data structure for management of a result set of a search XQuery trigger in the integrated query processing system in accordance with the present invention;

FIG. 5 shows a view for describing an example of an integrated query in accordance with the present invention;

FIG. 6 is a view for describing an example of a query for a search XQuery trigger extracted from the integrated query shown in FIG. 5; and

FIG. 7 represents a view for describing an example of a state where the search XQuery trigger created by using the query of FIG. 6 is involved in the integrated query of FIG. 5.

### DETAILED DESCRIPTION OF THE INVENTION

The above-mentioned objectives, features, and advantages will be more apparent by the following detailed description in association with the accompanying drawings; and thus, the invention will be readily conceived by those skilled in the art to which the invention pertains. Further, in the following description, well-known arts will not be described in detail if it seems that they could obscure the invention in unnecessary detail. Hereinafter, preferred embodiments of the present invention will be set forth in detail with reference to the accompanying drawings.

The present invention processes an integrated query or integrated continuous query against continuously inputted data stream and data stored in a database. Specifically, the present invention acquires a set of results of a trigger for the data stored in the database in advance by using the trigger, thereby solving performance reduction problem caused by an existing pull-based approach and thus improving overall query performance.

In the following description, an extensible Markup Language (XML) data stream and an XML database will be illustratively described under the concept that data transmitted between the internet and applications is based on an XML type.

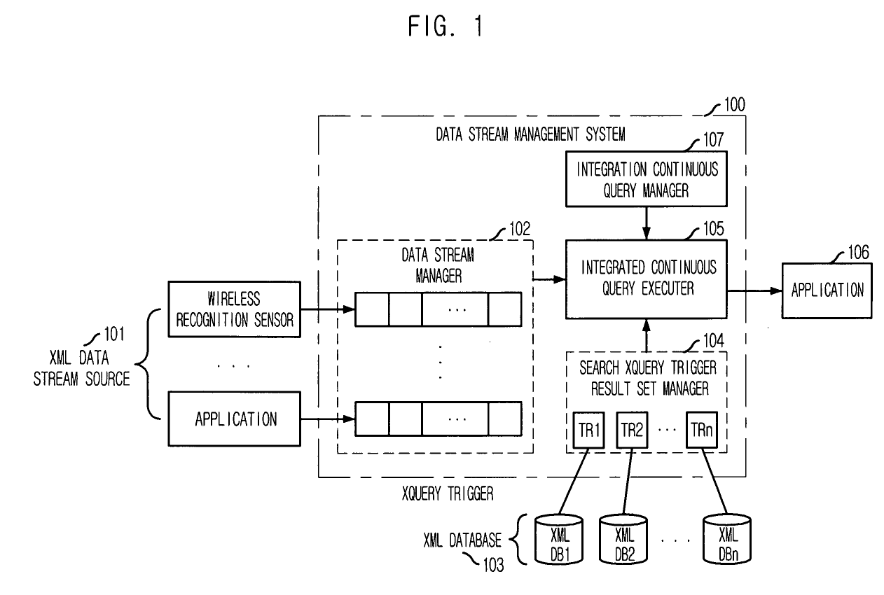

FIG. 1 is a block diagram showing a configuration of an integrated query processing system in accordance with a preferred embodiment of the present invention.

As shown in FIG. 1, the integrated query processing system of the present invention includes a data stream manager 102, a search XQuery trigger result manager 104, an integrated continuous query executer 105, and an integrated continuous query manager 107.

The data stream manager 102 manages XML data streams continuously inputted from a variety of external XML data stream sources 101. The search XQuery trigger result manager 104 registers a search XQuery trigger in one or more XML databases 103 and receives results of queries against each stored data in order to manage a set of the query results. The integrated continuous query executer 105 accepts the XML data stream from the data stream manager 102 and the set of process results of queries against each stored data from the search XQuery trigger result manager 104, processes an integrated query against the XML data stream and each stored data based on the accepted ones, and then transmits the process result to an application 106. Lastly, the integrated continuous query manager 107 serves to register/delete a continuous query.

More specifically, the search XQuery trigger result manager 104 takes the result of query against each stored data in real time from the one or more XML databases 103 which interwork with an XML data stream management system 100. For this, the search XQuery trigger result manager 104 registers a search XQuery trigger in each XML database 103 and makes the registered search XQuery trigger automatically executed whenever a change happens in data stored therein.

In other words, the XML database 103 carries out the preregistered search XQuery trigger when a change occurs therein, and provides the results to the search XQuery trigger result manager 104, thereby allowing the trigger result that the query process has been already completed to be referenced when processing the integrated continuous query. Accordingly, it is possible to improve overall query performance by overcoming the performance reduction by the pull-based approach for the data stored in the database.

Further, the XML database 103 registers therein an XQuery trigger query which complies with an XQuery syntax structure upon a separate request, and automatically executes the preregistered search XQuery trigger's query according to an addition, change, and deletion of XML data, thereby providing the result.

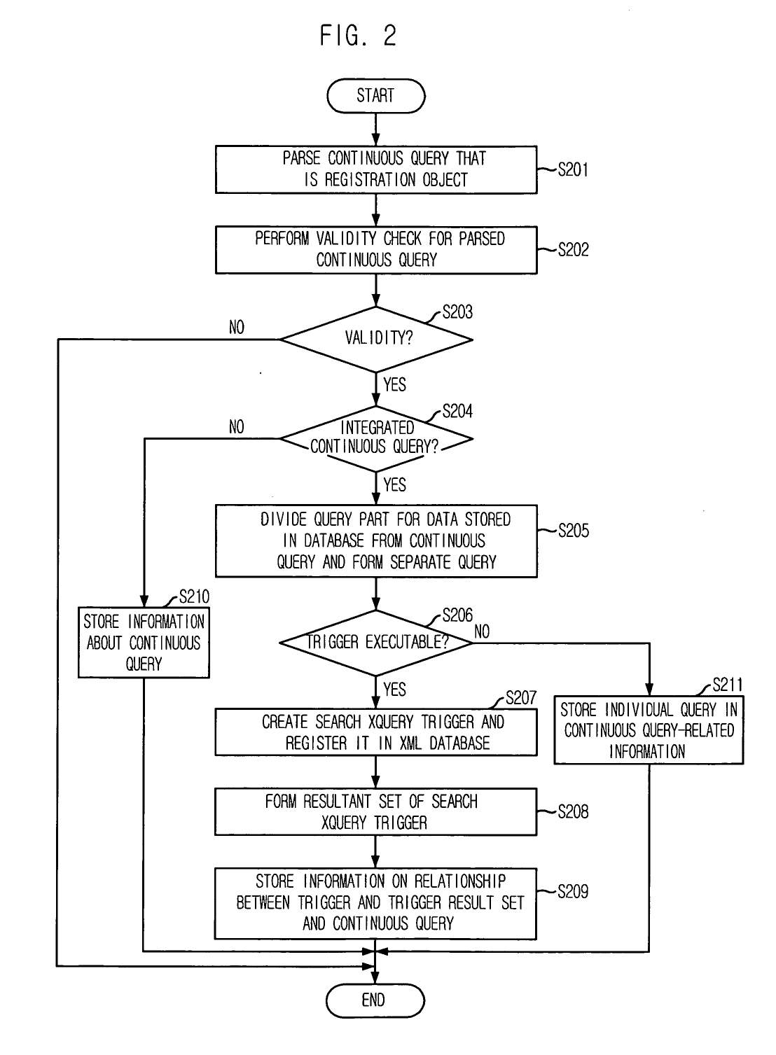

In the meantime, the integrated continuous query manager 107 serves to offer the functions of registering and deleting the continuous query; and conducts parsing and validity check upon registration of the continuous query as well as works by creation of trigger upon the integrated query, thereby establishing environment for the integrated continuous query executer 105. In addition, upon deletion of the continuous query, it is checked whether the trigger is to be deleted or not, wherein its related works are performed. A detailed operation related to the registration of the continuous query of the integrated continuous query manager 107 will be described later with reference to FIG. 2.

The XML data stream management system 100 continuously receives an XML data stream from the XML data stream source 101 such as various sensors having an external RFID sensor and applications, and interworks with the one or more XML databases 103 that support the search XQuery trigger to thereby enable access to the data stored therein. Further, the management system 100 executes an integrated query, i.e., integrated continuous query against the inputted XML data stream and the data stored in the XML database 103, and delivers the result to another application 106 in real time.

FIG. 2 shows a flowchart illustrating a procedure of registering an integrated continuous query against an input data stream and data stored in the database in an integrated query processing system in accordance with another preferred embodiment of the present invention.

First of all, the XML data stream management system 100 parses a continuous query that is an object of registration using an XQuery parser at step S201.

Next, a validity check for the parsed continuous query is performed at step S202, and it is judged at step S203 whether or not the parsed continuous query is valid. The validity check is made by checking whether or not there is a source to be queried through a syntax check, and whether or not data designation is valid.

If it is judged at step S203 that the parsed continuous query is not the valid continuous query, the process is ended.

Meanwhile, if it is judged at step S203 that the parsed continuous query is the valid continuous query, it is further judged at step S204 whether or not the passed continuous query is an integrated query, i.e., integrated continuous query.

If the judgment result is negative, information on the continuous query is stored at step 210.

Otherwise, that is, if the parsed continuous query is the integrated query, a query portion against the data stored in the XML database 103 is divided from the continuous query in order to form a separate query at step S205. Herein, the formed separate query is based on the XQuery syntax. At a next step S206, it is judged whether or not the formed separate query can be executed through a search XQuery trigger.

If it is judged at step S206 that the formed separate query can be executed through the search XQuery trigger, the search XQuery trigger is created and registered in the XML database 103 at step S207. And then, at step S208, a set of results of the search XQuery trigger returned from the XML database 103 is formed to thereby enable access thereto when processing an integrated continuous query. Thereafter, information on the relationship between the trigger and a trigger result set and the continuous query is stored at step S209.

On the other hand, if the judgment result at step S206 is negative, the separate query formed for the corresponding XML database 103 is stored in the continuous query-related information for later query processing at step S211.

The judgment on whether or not the formed separate query can be executed through the search XQuery trigger is decided based on whether or not the separate query has a value changed in real time. The query for the search XQuery trigger should not have such a value changed in real time as data stream value being inputted when processing the continuous query. Namely, the search XQuery trigger is registered in the XML database 103 and should be automatically executed whenever the XML database 103's change happens, and thus, the query should be stationary.

The integrated continuous query registered through the procedure as mentioned above is repeatedly executed against the data stream inputted to the XML data management system 100. On the other hand, the search XQuery trigger registered in the XML database 103 is automatically executed each time a change takes place therein, separately from the operation of the XML data stream management system 100. After that, the result set of the query is fed to the XML data management system 100. Accordingly, the XML data stream management system 100 executes the query for the data of the XML database 103 with reference to the result set of the search XQuery trigger when the integrated continuous query is processed with respect to the XML data stream and the data stored in the XML database 103.

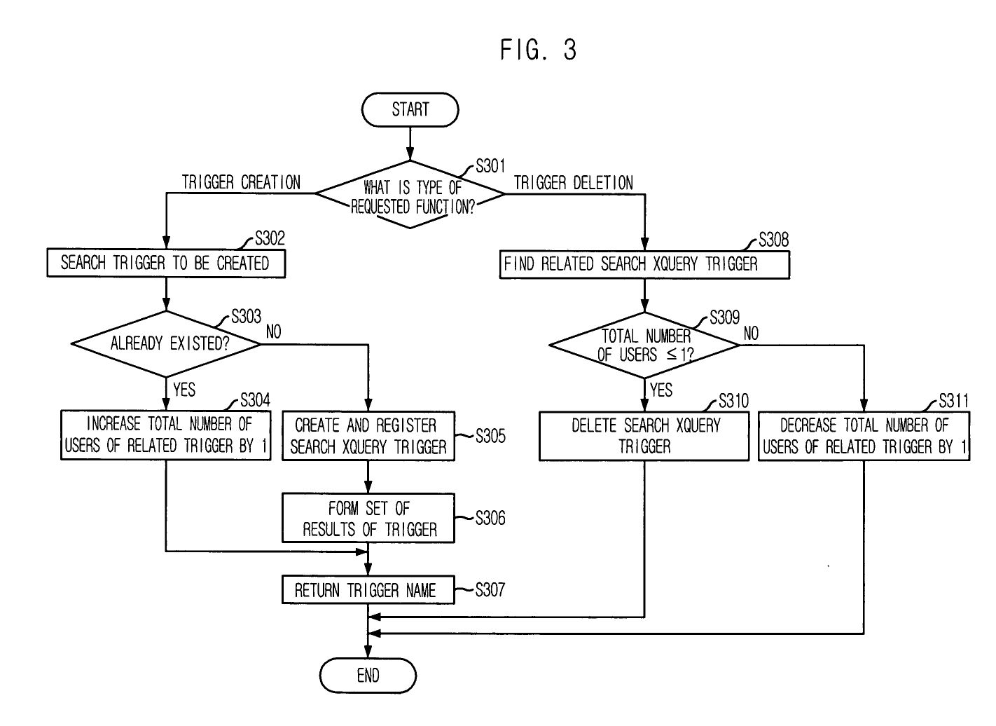

FIG. 3 shows a flowchart exemplifying a procedure of creating and deleting a search XQuery trigger in the integrated query processing system in accordance with another preferred embodiment of the present invention.

First of all, at step S301, it is judged whether a type of a request function of a search XQuery trigger is creation or deletion.

If it is judged at step S301 that the request type indicates a creation of a search XQuery trigger, the search XQuery trigger to be created is searched at step S302, and a presence or absence thereof is judged at step S303.

If it judged at step S303 that the search XQuery trigger to be created does not exist, the search XQuery trigger is created and registered in the related XML database 103 at step S305. Next, a set of results of the trigger generated together with creation thereof is formed in order to enable access thereto when processing the integrated query at step S306, and then a name of the search XQuery trigger is returned at step 307. At this time, the number of users is set to 1 after forming the set of trigger results. For instance, “there is a user” means “trigger was created.”

But, if it judged at step S303 that there already exists the search XQuery trigger to be created, the total number of users of the set of trigger results (correctly, the number of integrated queries) is increased by 1 at step S304, and the process goes to step S307 for returning the name of the search XQuery trigger.

Meanwhile, if it is judged at step S301 that the request type indicates a deletion of the search XQuery trigger, the search XQuery trigger is searched at step S308 and the total number of users of the set of trigger results is confirmed at step S309. If the confirmation result at step S309 shows that the total number of users is not greater than 1, the search XQuery trigger registered in the related XML database 103 is deleted at step 310. But, the confirmation result shows that the total number of users is greater than 1, then the total number of users is decreased by 1 at step S311, and the process is ended.

As described above, the set of results of the search XQuery trigger is formed for several integrated queries to share. That is, in case of a search XQuery trigger that already exists upon a creation request thereof, the name of the existing trigger is returned so that the newly created set of results can be used. In the same manner, in case where there is no object except for an object deletion-requested by a user of the result set upon a deletion request of the search XQuery trigger, the trigger and trigger result set are deleted. This sharing of the trigger and trigger result set provides optimization in terms of use of system resources.

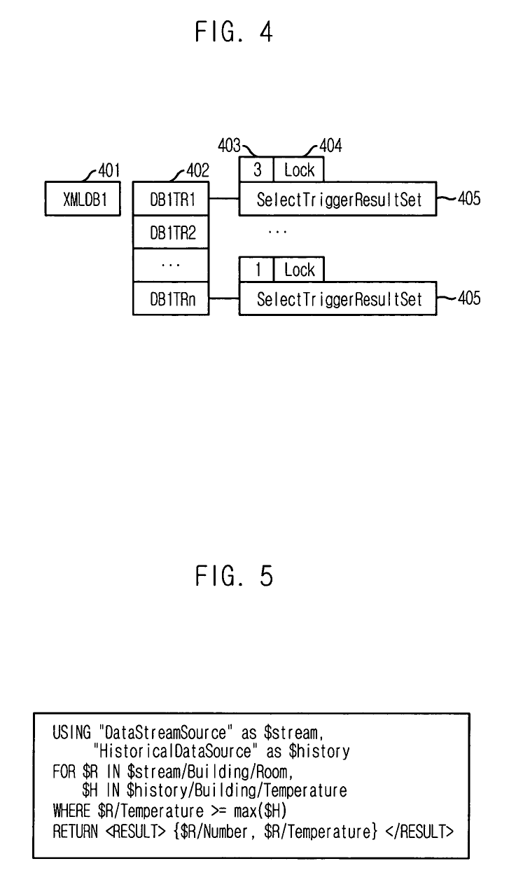

FIG. 4 shows an example of a data structure for management of a set of results of a search XQuery trigger in the integrated query processing system in accordance with the present invention.

As shown in FIG. 4, a result set list 402 of a search XQuery trigger corresponds to each XML database 103 in a one-to-one way, which interworks with the XML data stream management system 100. Herein, it shows an example of the XML database 103 named as “XMLDB1.”

The result set list 402 of the search XQuery trigger of “XMLDB1” contains all of the result set of the search XQuery trigger which is based on “XMLDB1.” A result set of a specific trigger is allowed to access thereto through a name of the trigger. The name of trigger is given to have uniqueness in the XML data stream management system 100 upon a creation of trigger.

Further, a result set 405 of a specific trigger contains a set of results that is obtained by executing a query related to the trigger, the total number of users 403, and information associated with a lock 404 required upon reference/change of result set. Herein, the number of users refers to the total number of integrated queries that are accessible to the result set of actual trigger, or being used. The number of users is 1 at a time when a trigger is initially created and its result set is formed, and is increased by 1 when a creation of the same trigger is requested thereafter. Conversely, the number of users is decreased by 1 when a deletion of the same trigger is requested. Lastly, the trigger and its result set are deleted at a time when the number of users becomes 0.

The result set of the search XQuery trigger is used together with the integrated query or integrated continuous query of the XML data stream management system 100 and the XML database 103. Herein, the integrated query can refer to i.e., read, the result set of trigger and the XML database 103 can change the result set of trigger. Therefore, the lock 404 management technique is employed in executing operation on the result set of trigger in order to prevent reading execution upon a change of the result set, and vice versa. In other words, it is required to acquire the lock in order to read or change the result set of trigger and release the lock after the reading and changing works are completed so that the reading and changing works are not performed together. The operations of queries against the XML database 103 and the XML data stream management system 100 are made separately from each other, and thus, it is possible to use the lock management technique due to smaller overhead.

FIG. 5 is a view for describing an example of an integrated query in accordance with the present invention.

As shown therein, an integrated query against an XML data stream applied to the XML data stream management system 100 and data stored in the XML database 103 is as follows. “FLWOR” may be configured based on XQuery; and because XQuery is made on the basis of a document while the data stream management system 100 is made based on data source, “USING” clause is extended for the above. Each data source can be identified by its name. That is, it can be seen whether each data source is a data stream source or XML database source depending on its name.

The following is a brief content of the integrated query. The content shows that it is required to create a room number and a current temperature as an element naming as “<REPORT>” if a value of “Building/Room/Temperature” in a data stream inputted from “DataStreamSource” is greater than a maximum value of “Building/Temperature” out of all data stored in “HistoricalDataSource,” and deliver it.

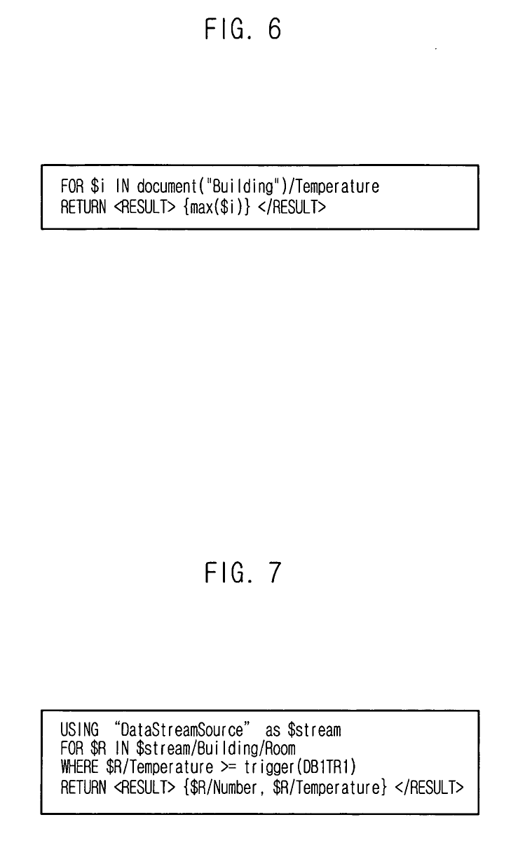

FIG. 6 is a view for explaining an example of a query for a search XQuery trigger extracted from the integrated query shown in FIG. 5.

A source of “HistoricalDataSource” is the XML database 103 and execution of XQuery is possible. And since interworking information thereon is acquired by the XML data stream management system 100, the search XQuery trigger is created by using the query of FIG. 6. The content of the query used in creating the search XQuery trigger is as follows: “search Temperature from documents named as Building and return maximum value.” At this time, the XML database 103 executes the query and returns its result value simultaneously with creation of the search XQuery trigger. After creating the search XQuery trigger, the query of the search XQuery trigger is executed and its results are returned to the XML data stream management system 100 whenever the document named as “Building” is added, deleted, or changed in the XML database 103.

FIG. 7 is a view for describing an example of a state where the search XQuery trigger created by using the query of FIG. 6 is involved in the integrated query of FIG. 5.

As illustrated therein, it can be known that the query portion against the XML database 103 is converted into a trigger function, thereby making it accessed to the result set of the search XQuery trigger by using its name when actually processing the integrated query.

As described above, the present invention can improve overall query performance by acquiring a query result against data stored in a database using a search XQuery trigger in advance when processing an integrated query against input data stream and the data stored in the database in a data stream management system.

In other words, the present invention can improve overall query performance by reduction in time spent for processing data stored in a database, by executing a query of a search XQuery trigger in real time whenever a change happens in the database to acquire its result set in advance, rather than processing the data stored in the database by a pull-based approach.

The method of the present invention as mentioned above may be implemented by a software program and stored in a computer-readable storage medium such as CD-ROM, RAM, ROM, floppy disk, hard disk, optical magnetic disk, etc. This process may be readily carried out by those skilled in the art; and therefore, details of thereof are omitted here for simplicity.

The present application contains subject matter related to Korean patent application Nos. 2005-0119397 and 2006-024423 filed with the Korean Intellectual Property Office on Dec. 8, 2005 and Mar. 16, 2006, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A system for processing an integrated query against an input data stream and data stored in a database using a trigger, comprising:
a data stream managing means for managing a continuously inputted data stream;
a trigger result managing means for registering a trigger in a database which interworks with the trigger result managing means and forming a set of results that are obtained by executing the registered trigger to thereby provide the set of results in real time; and
an execution means for processing an integrated query against the data stream from the data stream managing means and data stored in the database, wherein the integrated query is processed by referring to the set of results from the trigger result managing means for the data stored in the database.

2. The system as recited in claim 1, wherein the data stream managing means manages a continuously inputted extensible Markup Language (XML) data stream, and
the trigger result managing means registers a search XQuery trigger in one or more XML databases and forms a set of results that are obtained by executing the registered search XQuery trigger to provide the set of results in real time.

3. The system as recited in claim 1, wherein the trigger result managing means forms a set of results of trigger automatically executed when a change happens in the database.

4. The system as recited in claim 3, wherein the trigger result managing means manages information associated with the result of executing the query of the trigger, the total number of users, and lock as the set of results.

5. The system as recited in claim 4, wherein the trigger result managing means, upon request for creation of a trigger, increases the total number of users of the trigger by 1 when the trigger to be created already exists, and returns a name of the trigger.

6. The system as recited in claim 4, wherein the trigger result managing means, upon request for deletion of a trigger, decreases the total number of users of the trigger to be deleted by 1 when the total number is greater than 1.

7. The system as recited in claim 4, wherein the trigger result managing means performs an operation of the set of results of trigger by using a lock technique which performs the operation after acquisition of lock and release the lock after completion of the operation.

8. The system as recited in claim 3, wherein the trigger result managing means manages a list of the set of results to be corresponded to each of the one or more databases in a one-to-one way.

9. The system as recited in claim 3, wherein the execution means processes an integrated query against the data stream from the data stream managing means and processes against data stored in the database to provide the result to outside by using an XQuery trigger.

10. A method for processing an integrated query against an input data stream and data stored in a database using a trigger, comprising the steps of:
a) registering an integrated query;
b) registering a trigger for data stored in a database;
c) forming a set of results of the trigger automatically executed when a change happens in the database in real time;
d) receiving a continuously inputted data stream; and
e) processing the integrated query against the data stream and the data stored in the database, wherein the integrated query is executed by referring to the formed set of results for the data stored in the database.

11. The method as recited in claim 10, wherein in the step e), an integrated query is processed against a continuously inputted XML data stream and is processed against data stored in an XML databases by using an XQuery trigger.

12. The method as recited in claim 10, wherein an integrated continuous query is registered in the step a) by using an XQuery trigger.

13. The method as recited in claim 12, wherein the step a) includes the steps of:
a1) parsing a continuous query;
a2) confirming a validity for the parsed continuous query;
a3) confirming whether the continuous query is an integrated continuous query or not;
a4) dividing the integrated continuous query to form a separate query against the data stored in the database;
a5) creating a trigger and registering the trigger in the database when the formed separate query is executable through a trigger;
a6) executing the trigger to form a set of results of the trigger; and
a7) storing information on the relationship between the trigger and trigger result set and the continuous query.

14. The method as recited in claim 13, wherein the separate query is formed based on an XQuery syntax in the step a4).

15. The method as recited in claim 13, wherein in the step a5), the formed separate query is judged to be a query executable through the trigger when the separate query does not contain a value changed in real time.

16. The method as recited in claim 12, wherein in the step a6), information associated with the result of executing the query of the trigger, the total number of users, and a lock as the set of results is formed.

17. The method as recited in claim 16, wherein in the step b), upon request for creation of a trigger, the total number of users of the trigger is increased by 1 when the trigger to be created already exists.

18. The method as recited in claim 16, wherein in the step b), upon request for deletion of a trigger, the total number of users of the trigger to be deleted is decreased by 1 when the total number is greater than 1.
